(19) United States
(12) Patent Application Publication
(10) Pub. No.: US 2015/0031380 A1
(43) Pub. Date: Jan. 29, 2015

(54) COMMUNICATION METHOD, SYSTEM AND USER TERMINAL

(71) Applicant: NOKIA CORPORATION, Espoo (FI)

(72) Inventors: Antti TAKALIJOMA, Oulu (FI); Jyrki HOISKO, Oulu (FI); Heikki HUOMO, Cirencester (GB)

(21) Appl. No.: 14/514,169

(22) Filed: Oct. 14, 2014

Related U.S. Application Data
(63) Continuation of application No. 11/597,863, filed on Nov. 29, 2006, now abandoned.

(51) Int. Cl. H04W 76/02

(52) U.S. Cl. CPC H04W 76/02
USPC 455/450

(57) ABSTRACT

A communications system comprising one or more transponders and a user terminal including a processing unit, a reader unit for communicating with the transponders and a communications unit. The one or more transponders are configured to store connection specific information on the terminal device, and the reader unit of the user terminal is configured to receive the connection specific information on the terminal device stored in a transponder in response to the reader unit of the user terminal being positioned at least in proximity to the transponder, and the processing unit is configured to utilize the received connection specific information when a communications connection between the user terminal and the terminal device is established.

### FIELD

The invention relates to a communication method in a communications system, to a communications system, to a user terminal and to a transponder device.

### BACKGROUND

The number of different services and applications for use in communications devices has increased enormously in the past few years. For example, the users of mobile phones often also use their phones for other functions than for making actual phone calls. The users may send various kind of content between their devices, such as pictures, video clips, messages and program codes. However, there are a huge number of different devices on the market, and therefore establishing connections and sending content between the devices is not always so simple. The intended recipient may, for example, have several means of transmitting and receiving data. The sender may not be aware of all these possibilities. The sender may not know which of the transmission means the recipient refers or is capable of using. For example, the recipient may want to use the operator's image database, instead of downloading content directly to his/her phone.

Further, the immediate sending function is too complex; the user has to browse through the phone menu and choose appropriate transport mechanisms. The sending of content takes too long because there are multiple menus to select and use. It may also be difficult or almost impossible to send content while the user is mobile, for example, in a moving vehicle. Further, the usage situation may be difficult; the user may be at a disco, walking in a crowd, etc. Thus, due to external disturbance, sending content may be impossible. However, there are situations where the content may have to be sent immediately because later it may be forgotten, for example.

There are also situations where a service provider wishes to announce information that the customers may need when contacting the service provider. However, there may also be various preferred connection methods depending on the customer device, the network, and the service provider or external conditions. It is very difficult to affect the way the connection between the customer and the service provider is established.

There is a need for a method of simplifying the communication between different devices in communications systems.

### BRIEF DESCRIPTION OF THE INVENTION

An object of the invention is to provide an improved communication method and an improved communications system. According to an aspect of the invention, there is provided a communication method in a communications system, comprising storing connection specific information on a terminal device in one or more transponders, receiving the connection specific information on the terminal device at a user terminal in response to the user terminal being positioned at least in proximity to the transponder, and utilising the received connection specific information when a communications connection between the user terminal and the terminal device is established.

According to another aspect of the invention, there is provided a communications system, comprising one or more transponders being capable of storing data relating to a terminal device, and a user terminal including a processing unit for controlling the functions of the user terminal, a reader unit for communicating with the transponders, and a communications unit for establishing a communications connection between the user terminal and the terminal device. The one or more transponders are configured to store connection specific information on the terminal device, and the reader unit of the user terminal is configured to receive the connection specific information on the terminal device stored in a transponder in response to the reader unit of the user terminal being positioned at least in proximity to the transponder, and the processing unit is configured to utilise the received connection specific information when a communications connection between the user terminal and the terminal device is established.

According to another aspect of the invention, there is provided a user terminal of a communications system, comprising a processing unit for controlling the functions of the user terminal, a reader unit for communicating with one or more transponders capable of storing data relating to terminal devices, and a communications unit for establishing communications connections between the user terminal and terminal devices. The reader unit of the user terminal is configured to receive connection specific information on a terminal device from a transponder in response to the reader unit being positioned at least in proximity to the transponder, and the processing unit of the user terminal is configured to utilise the received connection specific information when a communications connection between the user terminal and the terminal device is established.

According to another aspect of the invention, there is provided a transponder device of a communications system, the transponder device comprising a memory for storing data relating to a terminal device of the communications system. The memory is configured to store connection specific information on the terminal device, and the transponder device is configured to disclose the connection specific information on the terminal device to a user terminal in response to the user terminal device being positioned at least in proximity to the transponder for enabling utilising the received connection specific information when a communications connection between the user terminal and the terminal device is established.

According to yet another aspect of the invention, there is provided a communications system, comprising one or more transponders being capable of storing data relating to a terminal device, and a user terminal including processing means for controlling the functions of the user terminal, communication means for communicating with the transponders and for establishing a communications connection between the user terminal and the terminal device. The one or more transponders comprising storing means for storing connection specific information on the terminal device, and the communication means of the user terminal are configured to receive the connection specific information on the terminal device stored in a transponder in response to the reader unit of the user terminal being positioned at least in proximity to the transponder, and the processing means are configured to utilise the received connection specific information when a communications connection between the user terminal and the terminal device is established.

The invention provides several advantages. The usability is greatly increased. Connection specific information is provided in a simple manner. The users are not required to know the capabilities of different devices when connections between them need to be established.

### LIST OF DRAWINGS

In the following, the invention will be described in greater detail with reference to the embodiments and the accompanying drawings, in which

FIG. 1 shows an example of a structure of a communications system;

FIG. 2 shows a structure of a communications system;

FIG. 3 illustrates an example of a communication method; and

FIG. 4 illustrates another example of a communication method.

### DESCRIPTION OF EMBODIMENTS

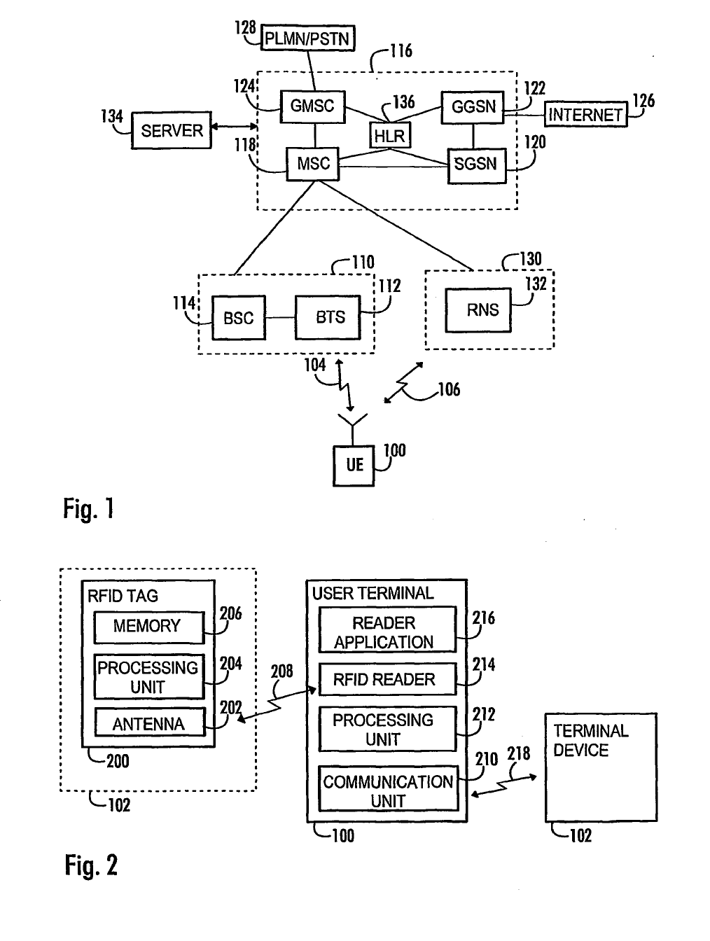

The embodiments of the invention are applicable in terminal devices, such as in mobile stations used as a terminal in telecommunications systems comprising one or more base stations and terminals communicating with the base stations. With reference to FIG. 1, examine an example of a structure of a communications system to which the preferred embodiments of the invention can be applied. The structure and functions of the elements of the system are not described in detail because they are generally known. The system in FIG. 1 is arranged to set up connections 104, 106 between different user terminals 100 in the communications system or between the user terminal 100 and an external network 126, 128, for example.

The main parts of a communications system are a core network 116, a base station system 110, a radio access network 130 and a user terminal 100. On a general level, the system can also be defined to comprise a terminal device, which is also known as a subscriber terminal and a mobile phone, for instance, and a network part, which comprises the fixed infrastructure of the communications system, i.e. the core network, radio access network and base station system.

The structure of the core network 116 corresponds to a combined structure of the GSM and GPRS systems. GSM network elements are responsible for establishing circuit-switched connections, and GPRS network elements are responsible for establishing packet-switched connections, some of the network elements being, however, used in both systems. A server 134 maintained by a service provider, such as an operator, controls the core network 116.

A mobile services switching centre (MSC) 118 is the centre point of the circuit-switched side of the core network 116. The same mobile services switching centre 118 can be used to serve the connections of both the radio access network 130 and the base station system 110. The tasks of the mobile services switching centre 118 include: switching, paging, user equipment location registration, handover management, collection of subscriber billing information, encryption parameter management, frequency allocation management, and echo cancellation.

Large core networks 116 may have a separate gateway mobile services switching centre (GMSC) 124, which takes care of circuit-switched connections between the core network 116 and external networks 128. An external network 128 can be for instance a public land mobile network (PLMN) or a public switched telephone network (PSTN).

A home location register (HLR) 136 contains a permanent subscriber register, i.e. the following information, for instance: an international mobile subscriber identity (IMSI), a mobile subscriber ISDN number (MSISDN), an authentication key, and when the radio system supports GPRS, a packet data protocol (PDP) address.

A serving GPRS support node (SGSN) 120 is the centre point of the packet-switched side of the core network 116. The main task of the serving GPRS support node 120 is to transmit and receive packets with the user terminal 100 supporting packet-switched transmission by using the radio access network 130 or the base station system 110. The serving GPRS support node 120 contains subscriber and location information related to the user terminal 100.

A gateway GPRS support node (GGSN) 122 is the packet-switched side counterpart of the gateway mobile services switching centre 124 of the circuit-switched side with the exception, however, that the gateway GPRS support node 122 must also be capable of routing traffic from the core network 116 to external networks 126, whereas the gateway mobile services switching centre 124 only routes incoming traffic. In our example, the Internet represents external networks 126.

SMSC (Short Message Service Centre) is an element (not shown) through which short messages are transmitted and in which they can be stored for later transmission if the receiver is not reached, for example.

The base station system 110 comprises a base station controller (BSC) 114 and a base transceiver station (BTS) 112. The base station controller 114 controls the base transceiver station 112. The base station controller 114 takes care of the following tasks, for instance: radio resource management of the base transceiver station 112, intercell handovers, frequency control, i.e. frequency allocation to the base transceiver station 112, management of frequency hopping sequences, time delay measurement on the uplink, implementation of the operation and maintenance interface, and power control.

The radio access network 130 comprises a radio network subsystem 132. The radio network subsystem is either the full part or only the access part of a UMTS terrestrial radio access network (UTRAN), providing allocation and release of specific radio resources to establish means of connection between the user terminal 100 and the UTRAN.

The user terminal 100 is e.g. a mobile phone or any another device including communication means, such as a personal digital assistant (PDA), a computer, handheld computer or an intelligent phone. The user terminal 100 contains at least one transceiver for establishing a communications link 104, 106 to the radio access network 130 or base station system 110. The user terminal 100 may also comprise the possibility of employing short-range communication; such as a transmitter-receiver function implemented using for example a Bluetooth chip, or an infrared or a WLAN connection. In addition, the user terminal 100 contains an antenna, a user interface and a battery.

FIG. 2 shows a structure of a communications system. In an embodiment, the communications system comprises a user terminal 100, a transponder device 200 and a terminal device 102.

The user terminal 100 includes a processing unit 212 for controlling the functions of the user terminal 100, a reader unit 214 for communicating with the transponders 200, and a communications unit 210 for establishing a communications connection between the user terminal 100 and the terminal device 102. It is possible that a user has the reader unit 214 in his user terminal 100 or as an accessory device outside the user terminal 100. The user terminal 100 also comprises a reader application 216, a middleware application (e.g. Myriad), for example.

The communications system may include one or more transponders 200 being capable of storing data relating to a terminal device 102. The transponder 200 may be a radio frequency identification (RFID) tag or any other means capable of storing data. The RFID is an inexpensive module that can be read from a distance with a reader antenna. The transponder 200 may, for example, include a bar code in the form of which the data is stored. The type of the bar code may comprise one of EAN (European Article Numbering), UPC (Universal Product Code) or EPC (Electronic Product Number) type codes. The transponder 200 may be a stand-alone device, i.e. situated outside the terminal device 102. It is also possible that the transponder 200 is included in the terminal device 102. In FIG. 2, the situation where the transponder 200 is included in the terminal device 102 is illustrated with a dashed line 102.

The transponder 200 may include a processing unit 204 for controlling the functions of the transponder 200, a memory 206 for storing data, and an antenna 202 for communicating. The transponder 200 may be a passive device or an active device. The active transponders 200 may include a battery for providing power to send different information from the transponder 200. The passive transponders 200 may use the radiation from the reader units 214 for obtaining necessary usage power.

The terminal device 102 may also be a user terminal type device, or for example a server computer that can be communicated with over a communications network, for example, over the Internet 126. The user of the terminal device 102 may thus be, for example, a service provider offering specific services in the communications system.

In an embodiment, the one or more transponders 200 are configured to store connection specific information on the terminal device 102. The connections specific information may be stored in the memory 206 of the transponder 200. It is possible that the user/operator of the terminal device 102 has stored the connection specific information in the transponder 200 by means of the terminal device 102. It is also possible that a given service provider has provided transponders 200 to include the connection specific information on the terminal device 102.

It is possible that a user has various transponders 200 including physical connection details of different terminal devices 102 belonging to his/her friends. A transponder 200 may be in the form of a “Connection Business Card”, for example. The transponders 200 can also be programmed by the user himself/herself, if a friend has sent his/her information in an electronic format earlier or the user has constructed the information himself/herself. The transponders 200 may also be like visiting cards that are given away to friends or customers, for example.

The connection specific information may include at least one of a Bluetooth MAC address, Bluetooth service discovery records, a wireless local area network (WLAN) MAC address, general packet radio service (GPRS) access parameters, a phone number for a short message service (SMS) access, phone number for a multimedia messaging service (MMS) access, a phone number for answering service, a public key (PKI), ICQ (I Seek You) or other Instant Messaging related parameters, an Internet protocol Home address and an E-Mail address.

The reader unit 214 of the user terminal 100 is configured to receive the connection specific information on the terminal device 102 stored in the transponder 200 in response to the reader unit 214 of the user terminal 100 being positioned at least in proximity to the transponder 200. The processing unit 212 of the user terminal 100 is then configured to utilise the received connection specific information when a communications connection between the user terminal 100 and the terminal device 102 is established.

The reader application 216 activates when the reader unit 214 has contacted the transponder 200 over a connection 208. The reader application 214 checks what is the content of the transponder. On the basis of the connection specific information received from the transponder 200, the reader application 214 may seek what is currently the best available transportation media. If the terminal device 102 is available through a “free” medium e.g. Bluetooth, it uses that, otherwise the MMS, SMS or GPRS may be used. The connection specific information may state which transportation medium is preferred first.

In an embodiment, the connection specific information may also include a list of preferred connections in a given order or a set of rules to be utilized when establishing a communications connection between the user terminal 100 and the terminal device 102. The connection specific information may also state which transportation medium is first preferred, and the user terminal 100 pursues to establish a communications connection between the user terminal 100 and the terminal device 102 over the transportation medium first preferred. The list of preferred connections may include different connection types to be tried in a specific order. The list may, for example, read out: a) Bluetooth (+details), b) WLAN (+details), c) GPRS (+details), d) GPRS #2 (+details), e) HSCSD (High Speed Circuit Switched Data), or simple rules like: “IF NOT Bluetooth THEN WLAN, IF NOT GPRS THEN HSCSD”.

In an embodiment, the one or more transponders 200 activate in response to the reader unit 214 of the user terminal 100 being positioned at least in proximity to the transponder 200. The user may, for example, touch the transponder 200 with his user terminal 100 or bring the user terminal 100 close to the transponder 200 for causing the transponder 200 to activate. The reader unit 214 is then configured to receive the connection specific information on the terminal device 102 when the transponder 200 is activated.

When a connection 218 between the user terminal 100 and the terminal device 102 is needed, the processing unit 212 of the user terminal 100 is configured to establish the communications connection 218 on the basis of the received connection specific information. It is possible that the communications connection 218 between the user terminal 100 and the terminal device 102 is established immediately once the connection specific information has been received in the user terminal 100.

In another embodiment, the processing unit 212 is configured to send a content of an active application of the user terminal 100 to the terminal device 102 over the established communications connection. It is possible that a user has a photo application active in the user terminal 100, and for example, a specific picture is shown on the display of the user terminal 100. If the user wishes to send this picture to the terminal device 102, all she/he has to do is to bring the user terminal 100 proximate to the transponder 200. Once the reader unit 214 detects the transponder being close, the connection specific information is transmitted from the transponder 200 to the user terminal 100. The reader application 216 then processes the received information and sends the results to the processing unit 212, for example. The processing unit 212 is configured to detect whether certain applications/content are active in the user terminal 100, and that being the case, to send the content to the terminal device 102 over a connection established on the basis of the received connection specific information.

In practice, an outsider may see that a user is taking a picture with his/her user terminal 100 and then touching his/her arm with the user terminal 100. In this case, there may have been a hidden transponder 200 in the users sleeve, for example. In fact, the user was sending the picture just taken to his/her friend by just touching his/her arm.

In an embodiment, the reader application 216 follows which application is active and has a window focus. Usually the user carries out data sending in an application by activating given window menus. Window menus, on the other hand, have ID (Identification) codes that the application is receiving from a Window Server (e.g. in Symbian OS (Operating System) or practically any other window-based graphical user interface OS). Based on the received Menu ID code, the reader application 216 can then carry out e.g. data sending. In an embodiment, it is possible that the reader application 216 tweaks this system by sending these same Menu ID codes to the active application (through Window Server) such as if they were initiated by the user from the Menus. Actually, the user had only touched an RFID tag, for example, with the RFID reader 214. Each application may have different Menu ID codes for their data sending, and some transportation means may not be available in all applications. The reader application 216 has knowledge on the different Menu ID codes and transportation means, for example.

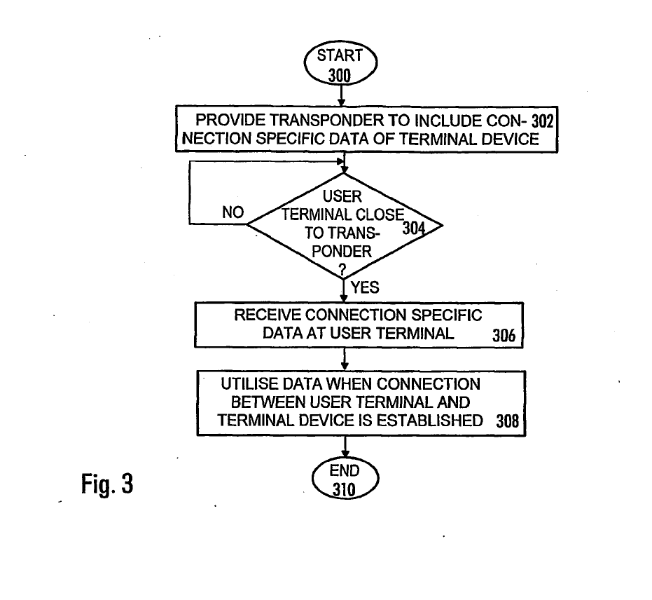

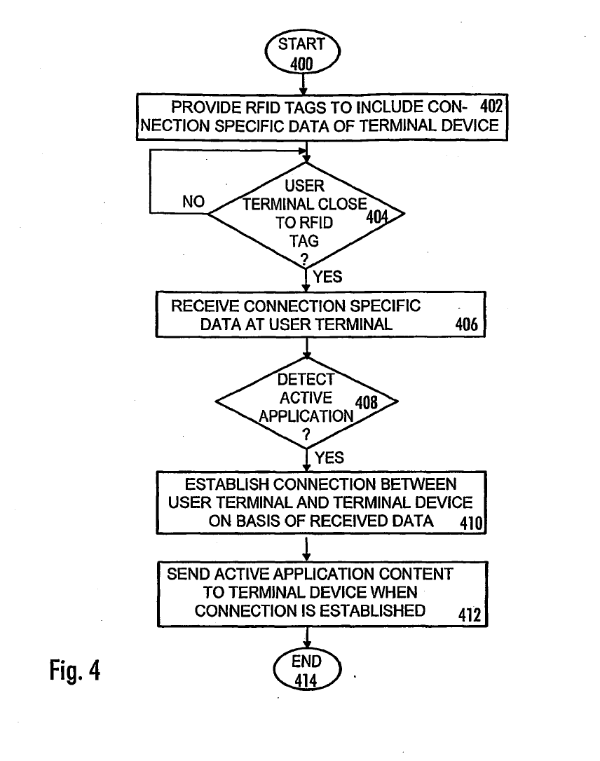

FIG. 3 illustrates an example of a communication method. The method starts in 300. In 302, connection specific information on a terminal device is stored in one or more transponders. In 304, it is detected whether a user terminal is positioned at least in proximity to the transponder. In 306, the connection specific information on the terminal device is received at the user terminal in response to the user terminal being positioned at least in proximity to the transponder. In 308, the received connection specific information is utilised when a communications connection between the user terminal and the terminal device is established. The method ends in 310.

FIG. 4 illustrates another example of a communication method. In this example, it is assumed that a user has a given application running on his/her user terminal. There is also some content available or the application is in some particular state that has meaning in a possible connection between two devices (e.g. initiating a connection between two game devices).

The method starts in 400. In 402, connection specific information on a terminal device is stored in one or more RFID tags. The RFID tags are associated to given persons or services and the user has knowledge about which parties the given RFID tags are referring to.

In 404, it is detected whether a user terminal is positioned at least in proximity to the transponder, and in 406, the connection specific information on the terminal device is received at the user terminal in response to the user terminal being positioned at least in proximity to the transponder. The user, for example, reads a specific RFID tag that refers to some person by bringing the user terminal close to the RFID tag.

In 408, a reader application of the user terminal detects whether there are active applications running on the user terminal, and that being the case, in 410, a connection is established between the user terminal and the terminal device that the RFID tag refers to in a given order specified in the RFID tag. In 412, when the connection is established, the content related to the active application is sent or exchanged. The content may be sent as an OBEX (Object Exchange) object or in some other known format. In an embodiment, the connection establishment may also involve launching of a specific application at the receiving end, that is, on the terminal device. The method ends in 414.

In an embodiment, a terminal device may be a personal computer comprising an RFID tag. It is possible that touching the personal computer where an application, e.g. PowerPoint, is active with a user terminal, sends a ppt file to the user terminal. Further, a data projector device may include another RFID tag, and touching the data projector with the user terminal then sends the ppt file to the data projector. In the background, these devices ensure privacy and security issues and there is no need to type pass codes or save files to temporary storages.

In an embodiment, it is possible that the RFID itself is used as a transportation medium. The terminal device and the user terminal may both be mobile phones that are brought together. The first phone is brought in proximity to the second phone including an RFID tag. Instead of opening any Bluetooth, WLAN or GPRS connection between the phones, an RFID protocol is used as the transportation medium. This medium also has the advantage of a better security. Because the users of the phones trust each other they let their phones touch, thus causing the phones to exchange data.

Even though the invention is described above with reference to an example according to the accompanying drawings, it is clear that the invention is not restricted thereto but it can be modified in several ways within the scope of the appended claims.

1. A method comprising:
causing, at least in part, a querying for subscriber information, location information, or a combination thereof for at least one device;
receiving connection specific information for the at least one device from one or more transponders based, at least in part, on the querying and
processing and/or facilitating a processing of the connection specific information to determine a means for transmitting content information.

2. A method of claim 1, wherein subscriber information includes, at least in part, an international mobile subscriber identity (IMSI), a mobile subscriber ISDN number (MSISDN), an authentication key, a packet data protocol (PDP) address, or a combination thereof.

3. A method of claim 1, wherein the connection specific information includes, at least in part, a Bluetooth MAC address, a Bluetooth service discovery record, a wireless local area network (WLAN) MAC address, a general packet radio service (GPRS) access parameter, a phone number for a short message service (SMS) access, a phone number for a multimedia messaging service (MMS) access, a phone number for an answering service, a public key (PKI), an instant messaging related parameter, a network address, an electronic mail address, or a combination thereof.

4. A method of claim 1, wherein connection specific information is stored in one or more transponders with one or more radio frequency identification (RFID) tags.

5. A method of claim 1, further comprising:
causing, at least in part, an establishment of a communication connection between the at least one device, at least one other device, or a combination thereof,
wherein the communication connection is based, at least in part, on capability of the at least one device to receive the content information.

6. A method of claim 5, further comprising:
causing, at least in part, a detection of at least one active application executing in the at least one device; and
causing, at least in part, a configuration of at least one other device to conform to the active application of the at least one device to send the content information over the communication connection.

7. A method of claim 6, further comprising:
causing, at least in part, a presentation of a window menu based, at least in part, on the at least one active application.

8. A method of claim 6, wherein the window menu includes, at least in part, one or more identification codes that the at least one application received from a window server, at least one other window-based graphical user interface, or a combination thereof.

9. A method of claim 1, further comprising:
causing, at least in part, an activation of at least one of the one or more transponders based, at least in part, on the location information, activity information, or a combination thereof of the at least one device.

10. A method of claim 9, further comprising:
causing, at least in part, a transmission of the content information from the at least one device to the at least one of the one or more transponders based, at least in part, on the location information, the activity information, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a querying for subscriber information, location information, or a combination thereof for at least one device;
receive connection specific information for the at least one device from one or more transponders based, at least in part, on the querying; and
process and/or facilitate a processing of the connection specific information to determine a means for transmitting content information.

12. An apparatus of claim 11, wherein subscriber information includes, at least in part, an international mobile subscriber identity (IMSI), a mobile subscriber ISDN number (MSISDN), an authentication key, a packet data protocol (PDP) address, or a combination thereof.

13. An apparatus of claim 11, wherein the connection specific information includes, at least in part, a Bluetooth MAC address, a Bluetooth service discovery record, a wireless local area network (WLAN) MAC address, a general packet radio service (GPRS) access parameter, a phone number for a short message service (SMS) access, a phone number for a multimedia messaging service (MMS) access, a phone number for an answering service, a public key (PKI), an instant messaging related parameter, a network address, an electronic mail address, or a combination thereof.

14. An apparatus of claim 11, wherein connection specific information is stored in one or more transponders with one or more radio frequency identification (RFID) tags.

15. An apparatus of claim 11, wherein the apparatus is further caused to:
cause, at least in part, an establishment of a communication connection between the at least one device, at least one other device, or a combination thereof,
wherein the communication connection is based, at least in part, on capability of the at least one device to receive the content information

16. An apparatus of claim 15, wherein the apparatus is further caused to:
cause, at least in part, a detection of at least one active application executing in the at least one device; and
cause, at least in part, a configuration of at least one other device to conform to the active application of the at least one device to send the content information over the communication connection.

17. An apparatus of claim 16, wherein the apparatus is further caused to:
cause, at least in part, a presentation of a window menu based, at least in part, on the at least one active application.

18. A computer-readable storage medium carrying one or more sequences of one or more instructions which, when executed by one or more processors, cause an apparatus to at least perform the following steps:
cause, at least in part, a querying for subscriber information, location information, or a combination thereof for at least one device;
receive connection specific information for the at least one device from one or more transponders based, at least in part, on the querying; and
process and/or facilitate a processing of the connection specific information to determine a means for transmitting content information.

19. A computer-readable storage medium of claim 18, wherein subscriber information includes, at least in part, an international mobile subscriber identity (IMSI), a mobile subscriber ISDN number (MSISDN), an authentication key, a packet data protocol (PDP) address, or a combination thereof.

20. A computer-readable storage medium of claim 18, wherein the connection specific information includes, at least in part, a Bluetooth MAC address, a Bluetooth service discovery record, a wireless local area network (WLAN) MAC address, a general packet radio service (GPRS) access parameter, a phone number for a short message service (SMS) access, a phone number for a multimedia messaging service (MMS) access, a phone number for an answering service, a public key (PKI), an instant messaging related parameter, a network address, an electronic mail address, or a combination thereof.
